(19) United States
(12) Patent Application Publication
(10) Pub. No.: US 2008/0004177 A1
(43) Pub. Date: Jan. 3, 2008

(54) Novel Copper-Containing Formulations

(76) Inventors: Thomas Pfeiffer, Bohl-Iggelheim (DE); Maximilian Angel, Schifferstadt (DE); Adolf Parg, Bad Durkheim (DE)

Correspondence Address: HUTCHISON LAW GROUP PLLC, PO BOX 31686, RALEIGH, NC, 27612, US

(21) Appl. No.: 10/575,215

(22) PCT Filed: Oct. 15, 2004
(86) PCT No.: PCT/EP04/11586

§ 371 Date: Apr. 10, 2006

(30) Foreign Application Priority Data
Oct. 17, 2003 (DE) 10349096.5

(51) Int. Cl. A01N 59/20; A01N 25/26; A01P 3/00

(52) U.S. Cl. 504/100; 424/638

(57) ABSTRACT

Fungicidal agrochemical compositions comprising
a) at least one copper salt and
b) polylysine and/or
c) at least one polylysine derivative,
   the use of polylysine, polylysine derivatives or a combination of polylysine and polylysine derivatives in copper-containing fungicidal formulations.

The present invention relates to fungicidal agrochemical compositions comprising

a) at least one copper salt and

b) polylysine, and/or

c) at least one polylysine derivative,

and also the use of polylysine, polylysine derivatives or a combination of polylysine and polylysine derivatives in copper-containing fungicidal formulations.

Copper salts have already been employed in agriculture for a long time for controlling phytopathogenic fungi on crop plants. To ensure the efficacy of the copper treatment of cultures over a prolonged period, inorganic copper salts which are sparingly soluble or insoluble in water, such as copper oxychloride, are used most frequently for this purpose.

Frequently, further additives such as complexing agents are added to the copper salt to improve its action and to reduce the application rate.

EP-A 39 788 describes copper amine salts of organic mono-, di- or polycarboxylic acids, where water-soluble, acidic copolymers based on acrylic acid or methacrylic acid and acrylic acid esters or methacrylic acid esters can be used as the polycarboxylic acids. EP-A 237 946 discloses copper amine salts of organic, water-soluble, acidic copolymers based on acrylic acid or methacrylic acid and acrylic acid esters or methacrylic acid esters.

Moreover, the use of copper salts based on low-molecular-weight organic carboxylic acids in oily formulations is known (cf. technical bulletin of Complex Quimica S.A. on Complex-200).

WO 02/083599 discloses fungicidally acting fertilizers which comprise a combination of alkali metal hydroxides and alkaline earth metal hydroxides, hydrolyzed peptides and copper salts such as, for example, copper hydroxide.

Surprisingly, it has now been found that the use of polylysine and/or polylysine derivatives in copper-containing fungicidal formulations improves the fungicidal activity, or brings about the same level of fungicidal activity with a reduced amount of copper or copper salt.

A further improvement in the activity, and thus a further reduction in the application rate, is achieved by admixing one or more fungicidal active ingredients. Here, a synergistically improved activity is observed in many cases.

The present invention therefore relates to fungicidal agrochemical compositions comprising

a) at least one copper salt,

b) polylysine, and/or

c) at least one polylysine derivative, and

d) optionally one or more fungicidal active ingredients,

e) optionally a solvent or solvent mixture,

f) optionally at least one basic nitrogen compound, and

g) optionally adjuvants which are suitable for the formulation.

The invention furthermore relates to the use of polylysine, polylysine derivatives or a combination of polylysine and polylysine derivatives in copper-containing fungicidal formulations for improving the activity.

The term copper salts a) is understood as meaning mono- or, preferably, divalent copper salts of inorganic and organic acids, for example copper oxychloride, copper octanoate, copper ammonium carbonate, copper arsenate, copper oxysulfate, copper formate, copper proprionate, copper oxyacetate, copper citrate, copper chloride, copper diammonium chloride, copper nitrate, copper carbonate, basic copper carbonate, copper pyrophosphate, copper phosphate, disodium copper EDTate, diammonium copper EDTate, copper oxalate, copper tartrate, copper gluconate, copper glycinate, copper glutamate, copper aspartate, copper glutonate, copper adipate, copper palmitate, copper stearate, copper caprylate, copper decanoate, copper undecylenate, copper neodecanoate, copper linoleate, copper oleate, copper borate, copper methanesulfonate, copper sulfamate, copper acetate, copper hydroxide, copper oxide, copper oxychloride sulfate, copper sulfate, basic copper sulfate, oxine-copper, copper bis(3-phenylsalicylate), copper dihydrazinium disulfate, dicopper chloride trihydroxide and tricopper dichloride dimethyldithiocarbamate. Other copper compounds which are suitable are mixed salts with ammonium, alkali metals and alkaline earth metals. Examples are ammonium copper(II) sulfate, copper(II) magnesium sulfate, copper naphthenate, copper 8-quinolate and copper(II) potassium sulfate. Preferably copper oxychloride, copper octanoate, copper ammonium carbonate, copper arsenate, copper(II) acetate arsenite, copper oxysulfate, copper formate, copper propionate, copper oxyacetate, copper citrate, copper carbonate, copper chloride, copper diammonium chloride, copper nitrate, copper carbonate, basic copper carbonate, copper pyrophosphate, copper phosphate, disodium copper EDTate, diammonium copper EDTate and copper acetate, copper hydroxide, copper oxide, copper oxychloride sulfate, copper sulfate, basic copper sulfate, oxine-copper, copper bis(3-phenylsalicylate), copper dihydrazinium disulfate, dicopper chloride trihydroxide, copper naphthenate, copper 8-quinolate and tricopper dichloride dimethyl-dithiocarbamate are used, especially preferably copper acetate, copper carbonate, copper oxychloride, copper hydroxide, copper oxide, copper oxychloride sulfate, copper sulfate, basic copper sulfate, oxine-copper, copper bis(3-(phenylsalicylate), copper dihydrazinium disulfate, dicopper chloride trihydroxide, copper octanoate, copper ammonium carbonate, copper arsenate, copper oxysulfate, copper naphthenate, copper 8-quinolate and tricopper dichloride dimethyidithiocarbamate.

Copper salts which are preferably used for solid, i.e. for example pulverulent or granulated formulations, are copper salts which are largely insoluble in water, such as copper oxychloride or copper hydroxide. Copper salts which are preferably used for liquid or dispersed formulations are soluble copper salts such as, for example, copper sulfate.

The term polylysine, which is chosen for component b), refers to crosslinked and non-crosslinked polymers or oligomers of lysine with an average molar mass (weight average) of from 300 to 2 000 000 g/mol. Polylysine with an average molar mass of from 500 to 100 000 g/mol is preferably employed. Polylysine with an average molar mass of from 1000 to 50 000 g/mol is especially preferred. The amino groups of the lysine units can be linked via the α and/or ε position. The polymer chains, in particular in the case of higher-molecular-weight polylysine, can be crosslinked by lysine by the two amino groups of a lysine unit reacting, the second amino group undergoing a condensation reaction with a further polylysine chain. Crosslinkages of this type can take place during the preparation of the polylysine as a function of the reaction conditions.

The preparation of polylysine is known and can be effected for example by the procedure described in JP 97-33122 or EP-A 256 423. While selective linkage of the lysine units via the ε-amino groups can be achieved by means of biocatalysis, condensation may also be effected via the thermal route, for example at temperatures above 100° C. via the α- and ε-amino groups; here, the ε-amino groups react preferentially.

In one embodiment of the compositions according to the invention, non-crosslinked polylysine (component b) is used.

The term polylysine derivative, which is chosen for component c), refers to crosslinked and non-crosslinked copolymers or cooligomers of lysine with further monomers which are capable of reacting with lysine. The monomers include amines and diamines, carboxylic acids, dicarboxylic acids, alkyldiketenes, lactones, lactams and amino acids (U.S. Pat. No. 6,111,057 and U.S. Pat. No. 6,034,204), and derivatives of the carboxylic and dicarboxylic acids in the form of their acid esters, acid amides, acid chlorides and acid anhydrides, it also being possible for more than one of the abovementioned monomers to undergo a condensation reaction with lysine in the form of mixtures. Other monomers which are suitable are isocyanates and diisocyanates. Polylysine derivatives with an average molar mass (weight average) of from 300 to 2 000 000 g/mol are employed. Polylysine derivatives with a molar mass of from 500 to 100 000 g/mol are preferably employed. Polylysine derivatives with a molar mass of from 1000 to 50 000 g/mol are especially preferably employed. In the case of the polylysine derivatives b), the lysine units present can be linked via the amino groups in α and/or ε position. In particular in the case of higher-molecular-weight polylysine derivatives, the polymer chains can be crosslinked by lysine and/or by the monomers which are additionally present, so that, when crosslinking is effected via a lysine unit, both amino groups of the lysine react (analogously to polylysine a), and/or, when crosslinking is effected via a monomer unit which is additionally present, the second functional group of the monomer reacts with a further chain of a polylysine derivative. This type of crosslinking can take place as a function of the reaction conditions during the preparation of the polylysine derivative. Non-crosslinked polylysine is preferably used.

Moreover, polylysine b) and polylysine derivatives c) may be alkoxylated (cf. WO 00/71601) and crosslinked (cf. WO 00/71600). In contrast to the possible crosslinking process which happens during the polymerization with, for example, lysine, this type of crosslinking takes place in a directed fashion and after the polymerization. Crosslinkers which are suitable are the compounds mentioned in WO 00/71600, such as, for example, bisglycidyl ethers of polyethylene glycol. Viscous solutions and even insoluble gels can be prepared by choosing the type of crosslinkers and the degree of crosslinking. The choice of crosslinker can also affect the film properties (for example extensibility, ultimate tensile, strength, modulus of elasticity, tackiness, solubility) of the copper-salt-comprising compositions according to the invention. This is particularly advantageous since it allows the release of the copper ions and the adherence of the mixtures or complexes or their films on surfaces to be controlled.

In a further embodiment of the compositions according to the invention, crosslinked polylysine, in particular polylysine which is obtainable by the processes described in WO 00/71600, is used.

Polylysine or polylysine derivatives can be prepared from lysine in enantiomerically pure form, in particular from the L-enantiomer, or from the D,L racemate, or a mixture of these. The thermal condensation can be effected as described in WO 00/71600.

The compositions according to the invention preferably comprise from 0.01 to 95% by weight, in particular from 0.01 to 50% by weight of polylysine and/or polylysine derivative. Copper salts account preferably for 0.01 to 80% by weight, in particular 0.01 to 50% by weight, based on copper.

The weight ratio of copper to polylysine and/or polylysine derivative is usually 1:100 to 20:1 parts by weight, in particular 1:20 to 20:1, preferably 1:7 to 10:1, especially preferably 1:5 to 3:1 parts by weight, especially preferably 1:3 to 1:1 parts by weight.

The compositions according to the invention may comprise, as further components, additionally at least one further fungicidal active ingredient (d); the following are particularly suitable:
Acylalanines such as benalaxyl, metalaxyl, ofurace, oxadixyl,
Amine derivatives such as aldimorph, dodine, dodemorph, fenpropimorph, fenpropidin, guazatine, iminoctadine, spiroxamin, tridemorph
Anilinopyrimidines such as pyrimethanil, mepanipyrim or cyrodinyl,
Antibiotics such as cycloheximide, griseofulvin, kasugamycin, natamycin, polyoxin, oxytetracyclin or streptomycin
Azoles such as bitertanol, bromoconazole, cyproconazole, difenoconazole, dinitroconazole, enilconazole, epoxiconazole, fenbuconazole, fluquiconazole, flusilazole, hexaconazole, imazalil, metconazole, myclobutanil, penconazole, propiconazole, prochloraz, prothioconazole, tebuconazole, triadimefon, triadimenol, triflumizol, triticonazole,
Dicarboximides such as iprodione, myclozoline, procymidone, vinclozoline,
Dithiocarbamates such as ferbam, nabam, maneb, mancozeb, metam, metiram, propineb, polycarbamate, thiram, ziram, zineb,
Heterocylic compounds such as anilazine, benomyl, boscalid, carbendazim, carboxin, oxycarboxin, cyazofamid, dithianon, famoxadone, fenamidone, fenarimol, fuberidazole, flutolanil, furametpyr, isoprothiolan, mepronil, nuarimol, probenazole, proquinazid, pyrifenox, pyroquilon, quinoxyfen, silthiofam, thiabendazole, thifluzamide, thiophanate-methyl, tiadinil, tricyclazole, triforine,
Nitrophenyl derivatives such as binapacryl, dinocap, dinobuton, nitrophthal-isopropyl
Phenylpyrroles such as fenpiclonil or fludioxonil,
Sulfur,
Other fungicides such as acibenzolar-S-methyl, benthiavalicarb, carpropamid, chlorothalonil, cyflufenamid, cymoxanil, dazomet, diclomezine, diclocymet, diethofencarb, edifenphos, ethaboxam, fenhexamid, fentin acetate, fenoxanil, ferimzone, fluazinam, fosetyl, fosetyl aluminum, phosphoric acid, iprovalicarb, hexachlorobenzene, metrafenon, pencycuron, propamocarb, phthalide, toloclofos-methyl, quintozene, zoxamid, benzalkonium chloride or hydroxyquinoline sulfates,
Strobilurins such as azoxystrobin, dimoxystrobin, fluoxastrobin, kresoxim-methyl, metominostrobin, orysastrobin, picoxystrobin, pyraclostrobin or trifloxystrobin,
Sulfenic acid derivatives such as captafol, captan, dichlofluanid, folpet, tolylfluanid
Cinnamamides and analogues such as dimethomorph, flumetover or flumorph.

Further examples of fungicidal active ingredients can be found in Pesticide Manual, 12th Edition, London ©2000 or in the Compendium of Pesticide Common Names on the Internet under http://www.hclrss.demon.co.uk/index.html.

Preferably, at least one of the fungicidal active ingredients from the abovementioned groups which are possible is employed as further active ingredient d). Especially preferably, the active ingredient is selected from the group consisting of the following active ingredients:
Acylalanines such as benalaxyl, metalaxyl, ofurace or oxadixyl,
Antibiotics such as cycloheximide, griseofulvin, kasugamycin, natamycin, polyoxin, oxytetracyclin or streptomycin,
Amine derivatives such as guazatine or iminoctadine
Azoles such as bitertanol, bromoconazole, cyproconazole, difenoconazole, dinitroconazole, epoxiconazole, fenbuconazole, fluquiconazole, flusilazol, hexaconazole, imazalil, metconazole, myclobutanil, penconazole, propiconazole, prochloraz, prothioconazole, tebuconazole, triadimefone, triadimenol, triflumizol, triticonazole,
Dithiocarbamates such as ferbam, nabam, maneb, mancozeb, metam, metiram, propineb, polycarbamate, thiram, ziram, zineb,
Heterocylic compounds such as anilazine, boscalid, carbendazim, cyazofamid, dithianon, famoxadone, fenamidone, flutolanil, furametpyr, mepronil, nuarimol, pyrifenox, silthiofam, thiabendazole, thifluzamide, thiophanate-methyl, tiadinil,
Sulfur,
Other fungicides such as acibenzolar-S-methyl, benthiavalicarb, chlorothalonil, cymoxanil, dazomet, diclomezine, diclocymet, diethofencarb, edifenphos, ethaboxam, fenhexamid, fentin acetate, fenoxanil, fluazinam, fosetyl, fosetyl-aluminum, phosphoric acid, iprovalicarb, hexachiorobenzene, pencycuron, propamocarb, quintozene, zoxamid, benzalkonium chloride or hydroxyquinoline sulfate,
Strobilurins such as azoxystrobin, dimoxystrobin, fluoxastrobin, kresoxim-methyl, metominostrobin, orysastrobin, picoxystrobin, pyraclostrobin or trifloxystrobin, and
Sulfenic acid derivatives such as captafol, captan, dichlofluanid, folpet, tolylfluanid
Cinnamamides and analogues such as dimethomorph, flumetover or flumorph.

Examples of synergistic mixtures comprising copper and further fungicidal active ingredients from the class of the strobilurins are disclosed for example in WO 97/15189 and WO 00/30450, these active ingredient combinations are especially preferred in the compositions according to the invention.

Examples of further particularly preferred mixtures of copper and at least one further fungicidal active ingredient are mixtures comprising
copper salt(s) and cymoxanil,
copper salt(s) and dichlorflunaid,
copper salt(s), cymoxanil and dichlorflunaid,
copper salt(s) and mancozeb,
copper salt(s), cymoxanil and mancozeb,
copper salt(s), cymoxanil and metiram,
copper salt(s) and dimethomorph,
copper salt(s) and hydroxyquinoline sulfates,
copper salt(s) and kasugamycin,
copper salt(s), mancozeb and sulfur,
copper salt(s) and maneb,
copper salt(s) and propineb,
copper salt(s), triadimefon and propineb,
copper salt(s) and zineb,
copper salt(s) and folpet,
copper salt(s) and carbendazim,
copper salt(s) and metalaxyl,
copper salt(s) and metiram,
copper salt(s) and benalaxyl,
copper salt(s) and chlorothalonil,
copper salt(s) and oxadixyl,
copper salt(s) and zineb,
copper salt(s) and sulfur,
copper salt(s) and benzalkonium chloride,
copper salt(s) and streptomycin and oxytetracyclin,
copper salt(s) and pyraclostrobin and
copper salt(s) and kresoxim-methyl.

The ratio of the further fungicidal active ingredient to copper in formulations according to the invention which comprise at least one further fungicidal active ingredient preferably amounts to from 50:1 to 1:1000, more preferably from 1:1 to 1:100, in particular from 1:3 to 1:10 (parts by weight active ingredient:copper).

Liquid formulations comprise solvent as further component (e), preferably from 0.1 to 98% by weight. Examples of suitable solvents are water, aromatic solvents (for example Solvesso Products, xylene), paraffins (for example mineral oil fractions), alcohols (for example methanol, butanol, pentanol, benzyl alcohol), ketones (for example cyclohexanone, gamma-butryolactone), pyrrolidones (NMP, NOP), acetates (glycol diacetate), glycols, dimethyl fatty acid amides, fatty acids and fatty acid esters. In principle, solvent mixtures may also be used. Solvents which are preferably employed are water, N-methylpyrrolidone (NMP), cyclohexanone and gamma-butyrolactone. Mixtures of various solvents may also be used.

Moreover, the compositions according to the invention can additionally comprise one or more basic nitrogen compounds as further component f), usually 0.1 to 80% by weight, such as ammonia (formation of copper amine complexes), primary and secondary amines such as, for example, ethylene diamine and propylene diamine, and basic amino acids, these preferably as L isomers, for example, lysine, preferably ammonia.

Preferably, 1 to 10, especially preferably 2 to 6, mole equivalents of the nitrogen compounds are present, based on copper. Also, 1 equivalent, less than 1 equivalent or even smaller amounts of nitrogen compounds may be present. Higher amounts, such as up to 50 equivalents, are also possible.

Moreover, the abovementioned compositions according to the invention may optionally also comprise further adjuvants g) which are suitable for the formulation. These are understood as meaning the following classes of substances:

Surfactants such as wetters, stickers or dispersants, antifoams, thickeners, carriers, antifreeze agents and bactericides.

Usually, 0.1 to 99% by weight, preferably 10 to 80% by weight, of carriers are present, in particular in solid formulations. Usually, 0.1 to 40% by weight of other adjuvants are present.

The importance and the corresponding use of the abovementioned substances depends on the intended type of formulation and on the nature of the active ingredient.

Examples of thickeners (i.e. compounds which impart pseudoplastic flow behavior to the formulation, i.e. high viscosity in the quiescent state and low viscosity in the agitated state) are, for example, polysaccharides or organic sheet minerals, such as xanthan gum (Kelzan® from Kelco), Rhodopol® 23 (Rhone Poulenc) or Veegum® (R.T. Vanderbilt) or Attaclay® (Engelhardt).

Examples of antifoams are silicon emulsions (such as, for example, Silikon® SRE, Wacker or Rhodorsil® from Rhodia), long-chain alcohols, fatty acids, organofluorine compounds and their mixtures.

Bactericides may be added to stabilize the aqueous fungicide formulation. Examples of suitable bactericides are Proxel® from ICI or Acticide® RS from Thor Chemie and Kathon® MK from Rohm & Haas.

Suitable antifreeze agents are, for example, ethylene glycol, propylene glycol or glycerol.

Examples of carriers are ground natural minerals, (for example kaolins, clays, talc, chalk) and ground synthetic materials (for example highly-dispersed silica, silicates), and examples of emulisifers are nonionic and anionic emulsifiers (for example polyoxyethylene fatty alcohol ethers, alkylsulfonates and arylsulfonates) and dispersants as mentioned hereinbelow.

Examples of surfactants are alkali metal salts, alkaline earth metal salts and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalene sulfonic acid with phenol and formaldehyde, polyoxyethylene octylphenol ether, ethoxylated isooctylphenol, octylphenol, nonylphenol, alkylphenyl polyglycol ethers, tributylphenyl polyglycol ether, tristerylphenyl polyglycol ether, alkylaryl polyether alcohols, alcohol and fatty alcohol ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and methylcellulose.

Examples of formulation types in this context are emulsifiable concentrates (EC, EW), suspensions (SC), soluble concentrates (SL), dispersible concentrates (DC), pastes, lozenges, wettable powders, dusts (DP) or granules (GR, FG, GG, MG) which can be either water-soluble or dispersible (wettable). The preparation of these formulations and the technology required for this is known to the skilled worker (cf. U.S. Pat. No. 3,060,084, EP-A-707 445 (for liquid concentrates), Browning, “Agglomeration”, Chemical Engineering, Dec. 4, 1967, 147-48, Perry's Chemical Engineer's Handbook, 4th Ed., McGraw-Hill, New York, 1963, pp. 8-57 et seq. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman, Weed Control as a Science, John Wiley and Sons, Inc., New York, 1961, Hance et al., Weed Control Handbook, 8th Ed., Blackwell Scientific Publications, Oxford, 1989 and Mollet, H., Grubemann, A., Formulation technology, Wiley VCH Verlag GmbH, Weinheim (Federal Republic of Germany), 2001).

Examples of formulations are: 1. Products for dilution in water

A Water-soluble Concentrates (SL)

10 parts by weight of a copper salt/polylysine mixture according to the invention are dissolved in water or a water-soluble solvent. As an alternative, wetters or other adjuvants are added. Dilution in water gives a solution.

B Dispersible Concentrates (DC)

20 parts by weight of a copper salt/polylysine mixture according to the invention are dissolved in cyclohexanone with addition of a dispersant, for example polyvinyl-pyrrolidone. Dilution in water gives a dispersion.

C Emulsifiable Concentrates (EC)

15 parts by weight of a copper salt/polylysine mixture according to the invention are dissolved in xylene with addition of calcium dodecylbenzenesulfonate and castor oil ethoxylate (in each case 5%). Dilution in water gives an emulsion.

D Emulsions (EW, EO)

40 parts by weight of a copper salt/polylysine mixture according to the invention are dissolved in xylene with addition of calcium dodecylbenzenesulfonate and castor oil ethoxylate (in each case 5%). This mixture is introduced into water using an emulsifier (Ultraturrax) and made into a homogeneous emulsion. Dilution in water gives an emulsion.

E Suspensions (SC, OD)

In an agitated ball mill, 20 parts by weight of a copper salt/polylysine mixture according to the invention are comminuted with addition of dispersants and wetters and water or an organic solvent to give a fine active ingredient suspension. Dilution in water gives a stable suspension.

F Water-dispersible and Water-soluble Granules (WG, SG)

50 parts by weight of a copper salt/polylysine mixture according to the invention are ground finely with addition of dispersants and wetters and made into water-dispersible or water-soluble granules by means of technical appliances (for example extrusion, spray tower, fluidized bed). Dilution in water gives a stable dispersion or solution.

G Water-dispersible and Water-soluble Powder (WP, SP)

75 parts by weight of a copper salt/polylysine mixture according to the invention are ground in a rotor-stator mill with addition of dispersants, wetters and silica gel. Dilution in water gives a stable dispersion or solution.

2. Products to be Applied Undiluted

H Dusts (DP)

5 parts by weight of a copper salt/polylysine mixture according to the invention are ground finely and mixed intimately with 95% of finely divided kaolin. This gives a dust.

I Granules (GR, FG, GG, MG)

0.5 part by weight of a copper salt/polylysine mixture according to the invention is ground finely and associated with 95.5% of carriers. Current methods are extrusion, spray-drying or the fluidized bed. This gives granules to be applied undiluted.

J ULV Solutions (UL)

10 parts by weight of a copper salt/polylysine mixture according to the invention are dissolved in an organic solvent, for example xylene. This gives a product to be applied undiluted.

Substances which are suitable for preparing directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone or water.

Powders, materials for spreading and dusts can be prepared by mixing or concomitantly grinding the active substances together with a solid carrier.

Granules, for example coated granules, impregnated granules and homogeneous granules can be prepared by binding the active ingredients to solid carriers. Examples of solid carriers are mineral earths such as silica gels, silicates, talc, kaolin, Attaclay, limestone, lime, chalk, bole, loess, clay, dolomite, diatomaceous earth, calcium sulfate, magnesium sulfate, magnesium oxide, ground synthetic materials, fertilizers such as, for example, ammonium sulfate, ammonium phosphate, ammonium nitrate, ureas and products of vegetable origin, such as cereal meal, tree bark meal, wood meal and nutshell meal, cellulose powder and other solid carriers.

All of the embodiments of the abovementioned fungicidally active agrochemical compositions are referred to as “compositions according to the invention”.

The present invention further relates to a process for the preparation of a composition according to the invention, which comprises treating the polylysine, the polylysine derivative or a mixture of polylysine and a polylysine derivative with at least one copper salt. This can be effected in the solid phase, for example by mixing the components, or in the liquid phase, for example by mixing the components in a solvent, using procedures known to the skilled worker. Suitable solvents are those mentioned under. (e).

In the case of preparation in liquid phase, the solvent can be removed once the preparation has ended or else remain in the composition according to the invention as further component (e). It is also possible to treat a solid composition according to the invention with a solvent (e) in a manner known per se.

The preparation of a composition according to the invention comprising, as further component, a basic nitrogen compound (f) and, if appropriate, a solvent (e) is preferably based on reacting, or mixing, the copper salt with a basic nitrogen compound (f). The resulting reaction product is reacted or mixed with polylysine and/or a polylysine derivative. A further preferred variant consists in first reacting or mixing the copper salt with polylysine and/or a polylysine derivative and then adding the basic nitrogen compound.

Moreover, adjuvants (g) may also be added during the preparation.

If required, the end product obtained can be dried prior to further processing.

The reaction can be carried out in a solvent by procedures known to the skilled worker. Suitable solvents are the solvents (e).

Composition(s) according to the invention which additionally comprise(s) at least one further fungicidal active ingredient (d) are hereinbelow referred to as “formulation(s) according to the invention”.

Formulations according to the invention can be prepared by treating copper, polylysine and/or at least one polylysine derivative together with at least one further fungicidal active ingredient and with adjuvants which are suitable for formulation, and formulating the mixture in a known manner.

As an alternative, the formulation according to the invention may also be prepared by treating the composition according to the invention together with at least one further fungicidal active ingredient and with adjuvants which are suitable for formulation and formulating the mixture in a known manner.

The formulation with the further fungicidal active ingredient and with the adjuvants which are suitable for the formulation can be prepared in the solid or liquid phase.

Furthermore, the formulation according to the invention can be obtained by treating the compositions according to the invention with an agrochemical formulation of a further fungicidal active ingredient.

An agrochemical formulation refers to all formulations of fungicidal active ingredients which comprise no copper, preferably to formulations of the fungicidal active ingredients which have been mentioned as being preferred.

Formulations according to the invention may also be obtained by adding polylysine and/or at least one polylysine derivative to a formulation which, in addition to copper as fungicidal active ingredient, may, if appropriate, comprise additionally at least one further fungicidal active ingredient.

Examples of commercially available formulations which comprise copper as fungicidal active ingredient are
Copper-Count-N*, Cupromin* (copper ammonium carbonate) Carbocob*, Carbocop*, Carboflow* (copper carbonate) Aciocide*, Cudrox*, Cuidrox*, Blue Shield*, Kocide*, Spin Out*, Hidrocop, Hidroflow*, Hydrocop*, Champ* DP, Champ*, Formula2*, Champinion*, Comac Parasol*, Cuproxide*, Parkens*, Funguran-OH*, Hermoo Koperhydroxide*, Koicide*, KOP* hydroxide, Qeusturan*, Nu-Cop*, Bordelesa*, FT-2*, Poltiglia Caffaro*, Bordocop*, Bordoflow*, Comac* (Bordeaux mixture) Flo-Bordo* (Bordeaux mixture and copper hydroxide) Chapco Cu-Nap*, Troysan*, Wittox C*, Wiltz-65* (copper naphthenate) Chem Copp*, Chemet AGcopp 75*, Cuprocop*, Cuprox*, Nordox Super 75, Oleo Nordox*, Nordox* S-45, Nordox* 50, Nordox* AgroTech, Parkenox-50, Parkens, Caocobre*, Copper Sandoz*, Cupra*, Nordox*, Ploxiram (copper oxide) Coptox*, Aviocaffaro*, Cuporcaffaro*, Neoram*, Pasta Caffaro*, Polvere Caffaro*, Rame Caffaro*, Criscobre*, COC*, KOP* OXY-85, CO-TOX*, Oxicop*, Oxycop*, Oxiflow, Cuprarikh-35*, Cuprarikh-50*, Parkens*, Cuprozin*, Nicuran*, Combat*, BluDiamdond*, TopGun*, Recop*, Kupoxil*, Acicio*, Agro-Bakir*, Agroram*, Blitox*, BlueCap*, Bluevit*, Cobox*, Cobre Lainco*, Coprantol*, Cupramar*, Cupravit*, Copter*, Coupradin*, Criscobre*, Crystal*, Cuprenox*, Cuprex*, Cuprossina*, Cuproflow*, Cuproxima*, Devicopper*, Dhanucop*, Dongoxyclorua*, Hektas Bakir*, Hilcopper*, Kapper*, Koruma Bakir*, Micorsperse*, Midiltipi Virfix Bakir*, Perecopper*, Pol-Kupritox* (copper oxychloride) Oxycop Dry S*, Copro*, Coxysul*, CS-56*, COCS*, CSC*, Oxycop* (copper oxychloride sulfate) Mitrol PQ*, Oxichem*, PQ-8* (copper 8-quinolate) Bouille Bordelaise RSR*, Hektas Goztasi*, Sulfacop*, Sulfacob*, Parkens*, Triangle Brand*, KT-19827*, Phyton-27*, (copper sulfate) Ramenox P.B. (copper sulfate and Bordeaux mixture) Cuprofix*, Disperss*, Cuprofix* MZ Dispers* Basic Copper 53*, Cop-O-Zinc 25-25*, Basicop*, Basiflow*, Tricop*, Copper Powder*, Flurame*, KOP 300*, (copper sulfate (basic)) Sultricob*, Sultricop*, Sultriflow*, Tribaflow*, Cuproxat*, Flurane*, Idorame*, King* (copper sulfate (tribasic)) *Trade name/®/™

Examples of commercially available formulations which, besides copper, additionally comprise at least one further fungicidal active ingredient are
Idroxanil*, Copral*, Kuoxoate*, Glober*, Expert Team* (copper salt(s) and cymoxanil) Bakreni Euparen* (copper salt(s) and dichlorfluanid) Euparen* Ramato Mirco CM (copper salt(s), cymoxanil and dichlorfluanid) Tripuprozeb Forte S*, Cuprofix*, Junction*, ManKocide*, Mantox-Forte*, Cuprofix* 30 (copper salt(s) and mancozeb), Zymoman*, Mantox*, Oxicob-mix* copper salt(s) (cymoxanil and mancozeb), Avis* Cup (copper salt(s), cymoxanil and metiram), Forum* RC (copper salt(s) and dimethomorph), copper salt(s) and hydroxyquinoline sulfate (Sellapro*), Kasumin*-Bordeaux, New Kasuran* (copper salt(s) and kasugamycin), Mantox-Forte*, Kuprosolor* (copper salt(s), macozeb and sulfur) Cuprofix* M, Herkul*, Cuprofix* M (copper salt(s) and maneb), Cupro-Antracol*, Antracol* copper, Antracol* Ramato Micro, Cupro-Antracol*, Cuprotaifen* (copper salt(s) and propineb), Antracol* Triple (copper salt(s), triadimefone and propineb), Cupro-Phynebe* (copper salt(s) and zineb), Cupror* F, Comac* 23-35, Macc* F23-35, SuperMacciesfield* F23-35, Folcoflow*, Folcop*, Nobac*, Tepeta*, Tepeta Combi* (copper salt(s) and folpet) Saynko* (copper salt(s) and carbendazim) CuMeta*, Ridomil Gold* copper, Aromil Plus*, Cure-Plus*, Vacomil plus*, Viroxyl* (copper salt(s) and metalaxyl) Kauritril* (copper salt(s) and metiram) Galben* C, Galben*, Tairel* C, Vilben-C* (copper salt(s) and benalaxyl) Clorocaf Ramato*, Gunner*, Citrano*, Optimist* (copper salt(s) and chlorothalonil) Sandofan* C (copper salt(s) and oxadixyl) Cuprosan*, Vizincop*, Zina* (copper salt(s) and zineb) COCS* 15 Sulfur 25 Dust, Copper/Sulfur Flowable*, TopCop* with sulfur (copper salt(s) and sulfur) Mossoff* (copper salt(s) and benzalkonium chloride) Cuprimicin*-500 (copper salt(s) and streptomycin and oxytetracyclin) *Trade name/®/™

In all of the abovementioned methods, the resulting formulations according to the invention (or the composition according to the invention and/or agrochemical formulation of a further fungicidal active ingredient) may be liquid or solid (for example EC, EW, SC, SL, DC, or wettable powders or water-dispersible granules which can be either soluble or dispersible (wettable) in water).

The compositions and formulations according to the invention are suitable for controlling phytopathogenic fungi. The present invention therefore relates to a method for controlling phytopathogenic fungi, which comprises applying a composition according to the invention to the harmful organism in question or to the materials, plants, soil and seeds to be protected from the harmful organism in question.

Moreover, the compositions and formulations according to the invention are suitable for controlling harmful fungi such as Paecilomyces variotii in the protection of materials (for example timber, paper, paint dispersions, fibers or wovens) and in the protection of stored products.

Depending on the type of compound and the desired effect, the application rates of the active ingredients are from 0.01 to 10 kg/ha, preferably 0.05 to 5 kg/ha, in particular 0.05 to 2 kg/ha.

In the treatment of seed, mixture application rates of from 0.1 to 2.5 kg/100 kg of seed, preferably 0.1 to 1.0 kg/100 kg, in particular 1 to 0.5 kg/100 kg, are generally used.

When used in the protection of materials or stored products, the application rate of composition depends on the nature of the field of application and the desired effect. Usual application rates in the protection of materials are, for example, from 0.0001 g to 2 kg, preferably 0.005 g to 1 kg, of copper/lysine mixture according to the invention per cubic meter of material to be treated. The application in the protection of timber is preferred.

The method for controlling harmful fungi is carried out by applying the formulation according to the invention by spraying or dusting the seeds, the plants or the soils before or after sowing of the plants or before or after emergence of the plants.

In this context, it is possible either directly to use a composition according to the invention or a formulation according to the invention or after diluting it with water, or to admix a composition according to the invention prior to application to the harmful organism in question or to the materials, plants, the soil and seeds to be protected from the harmful organism in question with a commercially available fungicidal formulation. As an alternative, it is possible to treat a copper-comprising formulation which, besides copper as fungicidal active ingredient, may, if appropriate, comprise at least one further fungicidal active ingredient, with polylysine and/or a polylysine derivative prior to application to the harmful organism. Examples of copper-comprising formulations which, besides copper as fungicidal active ingredient, may, if appropriate, comprise a further fungicidal active ingredient are abovementioned commercially available copper-comprising formulations.

Application of the fungicidal compositions may be effected curatively, eradicatively or protectively.

The formulations (or compositions) according to the invention are particularly important for controlling a multiplicity of phytopathogenic fungi on a variety of crop plants such as wheat, rye, barley, oats, rice; maize, turf, bananas, cotton, soy, coffee, sugarcane, vines, fruit species, ornamentals and vegetable species such as cucumbers, beans, tomatoes, potatoes and cucurbits, and on the seeds of these plants.

The formulations according to the invention are particularly advantageously suitable for controlling the following plant diseases:
Alternaria species on vegetable and fruit,
Bipolaris and Drechslera species on cereals, rice and turf,
Botrytis cinerea (gray mold) on strawberries, vegetables, ornamentals and vines,
Fusarium and Verticillium species on a variety of plants,
Hemileia vastatrix on coffee
Mycosphaerella species on cereals, bananas and peanuts,
Phytophthora infestans on potatoes and tomatoes;
Plasmopara viticola on vines,
Pseudoperonospora species on hops and cucumbers,
Septoria tritici and Stagonospora nodorum on wheat,
Ustilago species on cereals and sugarcane, and
Venturia species (scab) on apples and pears.

The invention is now explained by the examples which follow. Further compositions according to the invention are obtained by suitably modifying the starting materials or the quantity ratios.

### EXAMPLES

### Example 1

### Preparation of Polylysine

In a 2.4 liter pressure vessel, L-lysine monohydrate (821 g) and sodium hypophosphite (0.1 g) were heated for approximately 50 hours to 140-155° C. under nitrogen atmosphere, while the internal pressure rose to 5 bar. To check the course of the reaction, the reaction phase was interrupted after about 16 hours and once again after about 8 hours, a sample being taken each time. For this purpose in each case the pressure vessel was let down and cooled to room temperature. After a reaction phase of about 50 hours in all at 140° to 155° C. the reaction mixture was depressurized, cooled to room temperature, admixed with 641 g of water and filtered. This gave a viscous orange product with a solids content of 49.6% by weight and a K value (1% in water) of 18.1.

### Example 2

### Preparation of Polylysine

A 2.5 liter pressure vessel was charged with L-lysine monohydrate (821 g, 5.0 mol) and sodium hypophosphite (0.1 g) and the mixture was placed under a nitrogen atmosphere. Thereafter, the vessel was sealed in a pressure-tight manner and heated for 6 hours to 200° C., during which process the internal pressure climbed to 11.2 bar. Thereafter, the pressure was released slowly to atmospheric pressure in order to remove water from the reaction mixture. The reaction temperature was maintained at 200° C. for 0.5 hour to remove remaining solvent and volatile products. Thereafter, the reaction mixture was stirred for 25 minutes at 200° C. under a pressure of 20 mbar. The viscous melt was cooled to 115° C., discharged from the vessel and cooled to 20 to 25° C. The molecular weight MW of the polymer was 4300 g/mol.

### Example 3

### Preparation of a Polylysine Derivative

A 2.5 liter pressure vessel was charged with L-lysine monohydrate (656.8 g, 4.0 mol), aminocaproic acid (524.7 g, 4.0 mol) and sodium hypophosphite (0.1 g) and the mixture was placed under a nitrogen atmosphere. Thereafter, the vessel was sealed in a pressure-tight manner and heated for 7 hours to 196° C., during which process the internal pressure climbed to 8.2 bar. Thereafter, the pressure was released slowly to atmospheric pressure in order to remove volatile substances from the reaction mixture. The viscous melt obtained was discharged from the vessel and cooled to 20 to 25° C. The molecular weight MW of the polymer was 7400 g/mol.

### Example 4

### Preparation of Polylysine (Crosslinked)

In a 4-liter stirred vessel, 3000 g of prepared polylysine from Ex. 1 (25% strength aqueous solution) together with 540 g of 25% strength crosslinker (polyethylene glycol bisglycidyl ether with 14 ethylene glycol units) were heated to 72° C. within the course of 2 hours and subsequently, at 25° C., brought to pH 7 with hydrochloric acid. This gave a red viscous polymer. The product was subsequently diluted with water to a solids content of 19.8% by weight.

### Example 5

### Preparation of the Formulation “Polylysine”

98.25 g of an aqueous 20% by weight strength copper sulfate solution (copper salt:copper sulfate pentahydrate) were weighed with stirring into a 500 ml glass flask and treated with 126.5 g of water. Thereafter, 25.2 g of an aqueous solution from Ex. 1 comprising 49.6% by weight of polylysine were stirred in in the course of 15 minutes, and stirring was continued for 1 hour. This gave a dark blue dispersion with a copper (ion) content of 2% by weight. The weight ratio of polymer to copper was 2.5.

### Example 6

### Preparation of the Formulation “Polylysine with Ammonia”

98.25 g of an aqueous 20% by weight strength copper sulfate solution (copper salt:copper sulfate pentahydrate) were weighed with stirring into a 500 ml glass flask and treated with 94.3 g of water. Thereafter, 25.2 g of an aqueous solution from Ex. 1 comprising 49.6% by weight of polylysine were stirred in in the course of 15 minutes. 32.2 g of 25% strength ammonia were added to this solution, with stirring, and stirring was continued for 1 hour. This gave a blackish-blue solution with a copper (ion) content of 2% by weight. The weight ratio of polymer to copper was 2.5.

### Example 7

### Preparation of the Formulation “Crosslinked Polylysine”

98.25 g of an aqueous 20% by weight strength copper sulfate solution (copper salt:copper sulfate pentahydrate) were weighed with stirring into a 500 ml glass flask and treated with 88.2 g of water. Thereafter, 63.1 g of an aqueous solution from Ex. 2 comprising 19.8% by weight of crosslinked polylysine were stirred in in the course of 15 minutes, and stirring was continued for 1 hour. This gave a blackish-green solution with a copper (ion) content of 2% by weight. The weight ratio of polymer to copper was 2.5.

### Use Example 1

### Efficacy of the Formulations According to the Invention Against Downy Mildew of Grapevines, Caused by Plasmopara viticola

Leaves of grapevines cv. “Müller-Thurgau” in pots were sprayed to runoff point with aqueous suspension with the active ingredient concentration stated hereinbelow. The suspension or emulsion was made with a stock solution with 1% product in water. To allow the longer-term action of the substances to be assessed, the plants were placed in the greenhouse for 7 days after the spray coating had dried on. Only then were the leaves inoculated with an aqueous suspension of Plasmopara viticola. Thereafter, the vines were placed first for 48 hours into a chamber at 24° C. and 100% atmospheric humidity and then for 5 days in the greenhouse at temperatures of between 20° C. and 30° C. After this time, the plants were returned into a humid chamber for 16 hours to accelerate the eruption of sporangiophores. The extent of disease on the undersides of the leaves was then determined visually.

The visually determined values for the percentage of diseased leaf areas were converted into efficacies as % of the untreated control:

The efficacy (E) is calculated using Abbot's formula as follows:

E=(1−α/β)·100
α corresponds to the fungal infection level of the treated plants in % and
β corresponds to the fungal infection level of the untreated (control) plants in %

If the efficacy is 0, the infection level of the treated plant corresponds to that of the untreated control plants; if the efficacy is 100, the treated plants are not infected.

TABLE 1

| | Cu | | |
|---|---|---|---|
| | concentration | | |
| Example | [%] | Formulation | Efficacy |
| 1 | 0.02% | polylysine (2% copper) of | 88% |
| | | Example 5 | |
| 2 | 0.02% | polylysine/NH₃ (2% copper) of | 95% |
| | | Example 6 | |
| 3 | 0.02% | crosslinked polylysine (2% copper) | 88% |
| | | of Example 7 | |
| 4 | 0.45% | Funguran ® (commercial | 82% |
| | | copper fungicide; 45% copper) | |
| 5 | — | control | 0 |

The results shown in Table 1 demonstrate that the formulations according to the invention, which only comprised 2% of copper, were more effective using the same amounts than the commercially available formulation Funguran®, which comprises 45% copper.

### Use Example 2

### Efficacy of Formulations According to the Invention Comprising Copper and a Further Fungicidal Active Ingredient Against Septoria tritici

A growth assay was carried out with Septoria tritici as indicator fungus. The fungal growth was measured photometrically by the increase in absorption or light scattering as a function of mycelium density. The data obtained were converted into percent growth inhibition, the absorption of the untreated controls being defined as 0% inhibition and that of a killed spore suspension as reference as 100% inhibition.

The expected efficacies of combinations of active ingredients were determined using Colby's formula (Colby, S. R. (Calculating synergistic and antagonistic responses of herbicide combinations”, Weeds, 15, pp. 20-22, 1967)) and compared with the observed efficacies.

Colby's formula:

E=x+y−x·y/100
E expected efficacy, expressed in % of the untreated control, when using the mixture of the active ingredients A and B at the concentrations a and b
x efficacy, expressed in % of the untreated control, when using the active ingredient A at the concentration a
y efficacy, expressed in % of the untreated control, when using the active ingredient B at the concentration b

TABLE 2
Individual active ingredients

| | | | Active ingredient | Growth |
|---|---|---|---|---|
| | | | concentration in the | inhibition |
| Ex. | Active ingredient | Formulation | spray mixture [ppm] | [%] |
| 5 | Control | | — | 0 |
| | (untreated) | | | |
| 6 | I | polylysine/NH₃ | 1 | 54 |
| | copper | (Ex. 6) | 3 | 62 |
| | | | 10 | 54 |
| | | | 33 | 67 |
| 7 | II | — | 1 | 57 |
| | Pyraclostrobin | | | |

TABLE 3
mixtures according to the invention

| | Active ingredient mixture | | |
|---|---|---|---|
| | Concentration | | Calculated |
| Example | Mixing ratio | Observed efficacy | efficacy*) |
| 8 | I + II | 94 | 69 |
| | 1 + 1 ppm | | |
| | 1:1 | | |
| 9 | I + II | 90 | 65 |
| | 3 + 1 ppm | | |
| | 3:1 | | |
| 10 | I + II | 91 | 69 |
| | 10 + 1 ppm | | |
| | 10:1 | | |
| 11 | I + II | 84 | 62 |
| | 33 + 1 ppm | | |
| | 33:1 | | |

*)efficacy calculated using Colby's formula

The results of the experiments show that owing to the pronounced synergism, the mixtures according to the invention are considerably more effective than previously calculated using Colby's formula.

1-11. (canceled)

12. A fungicidal agrochemical composition comprising
a) at least one copper salt and
b) polylysine, and/or
c) at least one polylysine derivative.

13. The composition according to claim 12 which comprises, as additional component d), one or more further fungicidal active ingredients.

14. The composition according to claim 12, wherein the weight ratio of copper to polylysine and/or the polylysine derivative is from 1:100 to 20:1.

15. The composition according to claim 13, wherein the weight ratio of copper to polylysine and/or the polylysine derivative is from 1:100 to 20:1.

16. The composition according to claim 12, wherein the polylysine and/or polylysine derivative present is prepared on the basis of L-lysine.

17. The composition according to claim 12, which further comprises
e) a solvent, and/or
f) at least one basic nitrogen compound, and/or
g) adjuvants which are suitable for the composition.

18. The composition according to claim 13, which further comprises
e) a solvent, and/or
f) at least one basic nitrogen compound, and/or
g) adjuvants which are suitable for the composition.

19. The composition according to claim 15, which further comprises
e) a solvent, and/or
f) at least one basic nitrogen compound, and/or
g) adjuvants which are suitable for the composition.

20. A process for the preparation of an agrochemical composition comprising
a) at least one copper salt and
b) polylysine, and/or
c) at least one polylysine derivative,
which process comprises treating polylysine, polylysine derivative or a polylysine and polylysine derivatives mixture with at least one copper salt.

21. The process according to claim 20, wherein the weight ratio of copper to polylysine and/or the polylysine derivative in the agrochemical composition is from 1:100 to 20:1.

22. A process for the preparation of an agrochemical composition comprising
at least one copper salt and
polylysine, and one or more further fungicidal active ingredients, and/or
at least one polylysine derivative and/or
a solvent, and/or
at least one basic nitrogen compound, and/or
adjuvants which are suitable for the composition said process comprising:
a) treating copper salt(s), polylysine and/or at least one polylysine derivative together with at least one further fungicidal active ingredient and with adjuvants which are suitable for the composition and formulating the resulting mixture; or
b) treating an agrochemical composition comprising at least one copper salt and polylysine, and/or at least one polylysine derivative, together with at least one further fungicidal active ingredient and with adjuvants which are suitable for the composition and formulating the resulting mixture; or
c) treating an agrochemical composition comprising at least one copper salt and polylysine, and/or at least one polylysine derivative, and one or more further fungicidal active ingredients, together with an agrochemical formulation of a further fungicidal active ingredient; or
d) treating a copper-containing agrochemical composition which, in addition to copper salt(s), comprises at least one further fungicidal active ingredient, with polylysine and/or a polylysine derivative.

23. A method for preparing a fungicidal formulation comprising adding polylysine, polylysine derivatives or a combination of polylysine and polylysine derivatives to copper-containing fungicidal compositions.

24. A method for controlling phytopathogenic fungi, which comprises applying an agrochemical composition comprising
a) at least one copper salt and
b) polylysine, and/or
c) at least one polylysine derivative
to the pest in question or to the materials, plants, soil and/or seeds to be protected from the harmful organism in question.

25. The method of claim 24, wherein the agrochemical composition further comprises, as additional component d), one or more further fungicidal active ingredients.

26. The method of claim 24, wherein the weight ratio of copper to polylysine and/or the polylysine derivative is from 1:100 to 20:1.

27. The method of claim 25, wherein the agrochemical composition further comprises
e) a solvent, and/or
f) at least one basic nitrogen compound, and/or
g) adjuvants which are suitable for the composition.

28. Seed comprising a composition comprising at least one copper salt and polylysine, and/or at least one polylysine derivative, in an amount of from 0.1 to 2.5 kg/100 kg.

29. A material comprising a composition comprising at least one copper salt and polylysine, and/or at least one polylysine derivative, in amounts of from 0.0001 g to 2 kg per cubic meter.

30. The material of claim 29 wherein the composition further comprises one or more further fungicidal active ingredients.

31. Timber comprising a composition comprising at least one copper salt and polylysine, and/or at least one polylysine derivative, in amounts of from 0.0001 g to 2 kg per cubic meter.
